(19) United States
(12) Patent Application Publication
(10) Pub. No.: US 2016/0139020 A1
(43) Pub. Date: May 19, 2016

(54) INSTALLATION AND METHOD FOR DETERMINING THE DIFFUSION PROFILE OF AT LEAST ONE MOLECULE THROUGH SKIN

(71) Applicant: L'OREAL, Paris (FR)

(72) Inventors: Alexandre Nicolas, Tokyo (JP); Sébastien Gregoire, Thorigny-sur-mame (FR); Christophe Provin, Tokyo (JP); Christophe Hadjur, Singapore (SG); Teruo Fujii, Tokyo (JP)

(21) Appl. No.: 14/891,465

(22) PCT Filed: May 16, 2013
(86) PCT No.: PCT/IB2013/001346

§ 371 Date: Nov. 17, 2015

(51) Int. Cl. G01N 13/00; G01N 27/403; G01N 27/07; G01N 21/84

(52) U.S. Cl. CPC G01N 13/00; G01N 21/84; G01N 27/403; G01N 27/07; G01N 2013/003

(57) ABSTRACT

The invention relates to an installation (1) for determining the diffusion profile of at least one molecule through skin, comprising:
a microfluidic chip (4) comprising:
   a donor compartment (10) intended to contain a test solution comprising the or each molecule;
   a receptor compartment (12) intended to contain a receptor solution; and
   a membrane (14) with skin-mimetic barrier properties arranged between the donor compartment (10) and the receptor compartment (12) so that the test solution diffuses through the membrane (14) from the donor compartment (10) into the receptor compartment (12);
and
an analyzer (8) for measuring a physical parameter of the solution contained in the receptor compartment (12) as the test solution diffuses through the membrane (14), and said analyzer (8) being configured for measuring the physical parameter in the receptor compartment (12), the analyzer (8) being further configured for calculating the diffusion profile of the or each molecule through skin from the measured physical parameter.

The present invention concerns an installation for determining the diffusion profile of at least one molecule through skin.

In the cosmetics field, safety and efficiency are key aspects when developing new products. Since the skin is the first and main barrier against external agents, in order to evaluate the safety and efficiency of new cosmetic molecules or compositions, it is important to be able to measure their properties of diffusion through the skin.

For this purpose, there exists in silico methods which predict the diffusion properties of chemical molecules based on theoretical chemical models thereof.

These methods are not entirely satisfactory. Indeed, the predictions provided by these methods can only be considered as estimations and do not provide a real evaluation of the skin absorption of the molecules according to their conditions of use, such as their formulation, dose etc.

For this reason, only diffusion tests carried out on ex vivo skin are accepted by regulatory authorities.

It has been proposed to evaluate the diffusion properties of molecules through skin using so-called “Franz cells”. These installations comprise a donor compartment and a receptor compartment separated by a piece of native skin. Both the donor compartment and the receptor compartment are macroscopic in size. The test solution containing the molecule to be tested is introduced into the donor compartment and diffuses through the skin into the receptor compartment containing a buffer receptor solution. The solution contained in the receptor compartment is continuously stirred. Samples are periodically extracted from the receptor compartment. At the end of the test, the Franz cell is dismantled and the content of the molecule to be tested in the skin itself and in the samples is analyzed. The diffusion properties of the molecule to be tested are obtained from this analysis.

This installation is not entirely satisfactory. Indeed, the necessity to periodically extract samples and to dismantle the cell after each experiment makes it inconvenient to use and furthermore does not allow for a high throughput of molecules.

A purpose of the invention is to provide an installation for determining the diffusion profile of a molecule through skin which is simple to use and allows for a high throughput of molecules to be tested.

To this end, the invention relates to an installation as described above, wherein the installation comprises:

a microfluidic chip comprising:
a donor compartment intended to contain a test solution comprising the or each molecule;
a receptor compartment intended to contain a receptor solution; and
a membrane with skin-mimetic barrier properties arranged between the donor compartment and the receptor compartment so that the test solution diffuses through the membrane from the donor compartment into the receptor compartment; and

an analyzer configured for measuring a physical parameter of the solution contained in the receptor compartment as the test solution diffuses through the membrane, and said analyzer being configured for measuring the physical parameter in the receptor compartment, the analyzer being further configured for calculating the diffusion profile of the or each molecule through skin from the measured physical parameter.

According to particular embodiments, the installation may comprise one or more of the features of claims 2 to 14, taken alone or according to any technically possible combination.

The invention also relates to a method for determining the diffusion profile of at least one molecule through skin according to claim 15.

According to another object, the invention relates to an installation for determining the diffusion profile of at least one molecule through skin, comprising:

a microfluidic chip comprising:
a donor compartment intended to contain a test solution comprising the or each molecule;
a receptor compartment intended to contain a receptor solution, wherein the receptor compartment has a volume smaller than 250 mm³, advantageously smaller or equal to 100 mm³, and more particularly smaller or equal to 20 mm³; and
a membrane with skin-mimetic barrier properties arranged between the donor compartment and the receptor compartment so that the test solution diffuses through the membrane from the donor compartment into the receptor compartment; and

an analyzer configured for measuring a physical parameter of the solution contained in the receptor compartment as the test solution diffuses through the membrane and for calculating the diffusion profile of the or each molecule from the measured physical parameter.

According to particular embodiments, the installation may further comprise one or more of the following features:
the analyzer comprises a measurement tool configured for measuring the physical parameter of the solution contained in the receptor compartment outside of the receptor compartment;
the analyzer comprises a means for extracting a sample of the solution contained in the receptor compartment from the receptor compartment and for transferring it to the measurement tool, the measurement tool being configured for measuring the physical parameter on this sample;
the analyzer is configured for analyzing the samples extracted from the receptor compartment at a predetermined frequency;
the measurement tool is a mass spectrometer and the physical parameter is the mass to charge ratio of the molecule to be tested in the analyzed samples;
the analyzer is able to determine the evolution of the concentration of the molecule to be tested in the solution contained in the receptor compartment from the measure of the physical parameter in the samples;
the analyzer is able to determine the diffusion profile of the molecule to be tested through the membrane from the evolution of the concentration of this molecule to be tested in the solution contained in the receptor compartment.

The invention also relates to a method for determining the diffusion profile of at least one molecule through skin using the installation described above.

The invention will be better understood upon reading the following specification made solely by way of example and with reference to the appended figures, wherein:

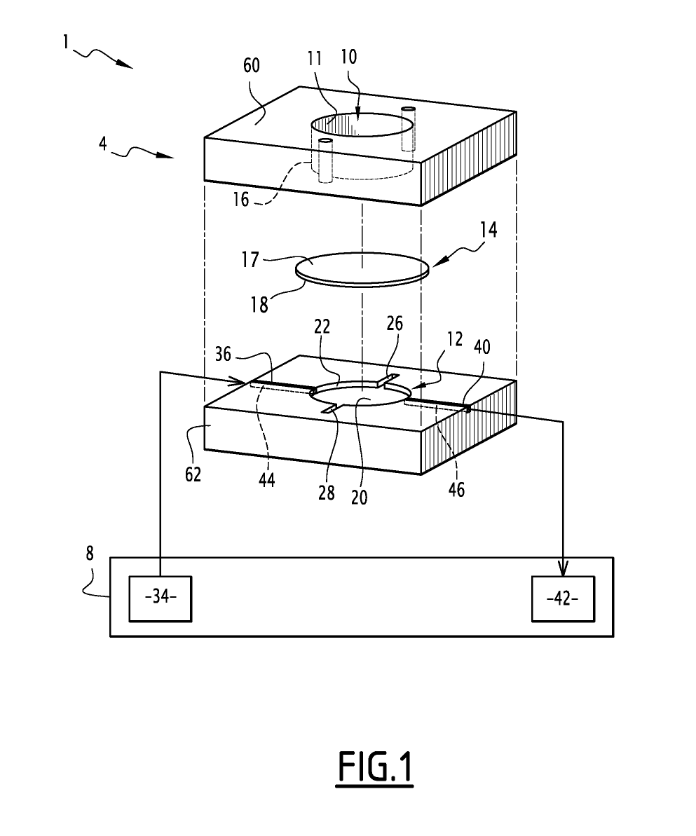

FIG. 1 is a schematic exploded perspective view of the installation according to a first embodiment of the invention;

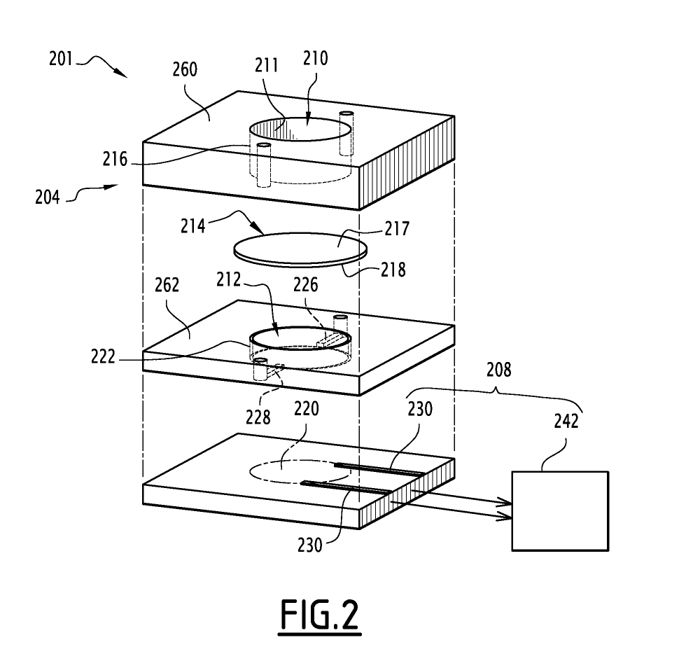

FIG. 2 is a schematic exploded perspective view of the installation according to a second embodiment of the invention; and

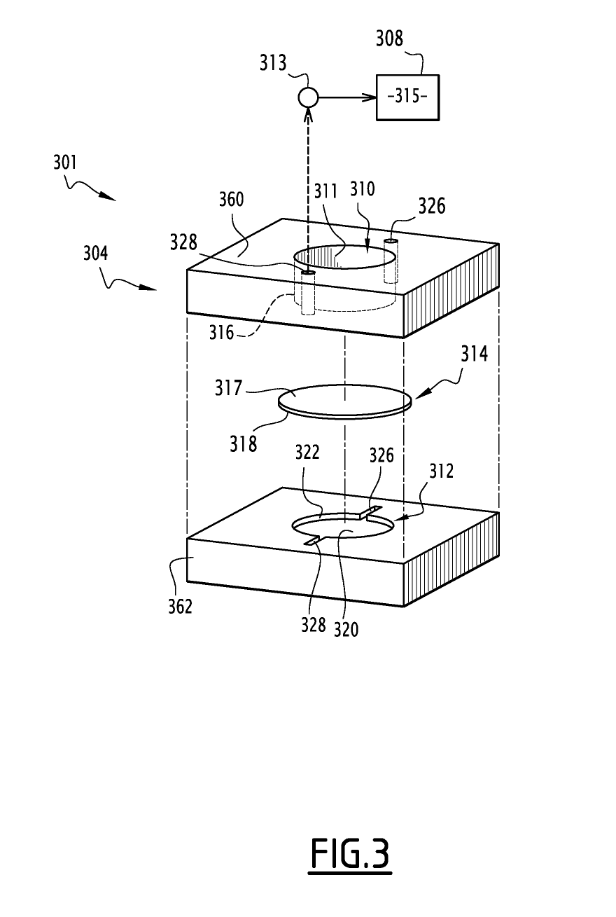

FIG. 3 is a schematic exploded perspective view of the installation according to another object of the invention.

An installation 1 for determining the diffusion profile of at least one molecule through skin according to a first embodiment of the invention is shown in FIG. 1.

The installation 1 comprises a microfluidic chip 4 and an analyzer 8 for determining the diffusion profile of the or each molecule through the skin.

More particularly, the microfluidic chip 4 comprises:
a donor compartment 10 intended to contain a test solution comprising the or each molecule to be tested;
a receptor compartment 12 intended to contain a receptor solution; and
a membrane 14 arranged between the donor compartment 10 and the receptor compartment 12 so that the test solution diffuses through the membrane 14 from the donor compartment 10 into the receptor compartment 12.

The test solution diffuses through the microfluidic chip 4 substantially along a direction of diffusion. In the following specification:

“Top” and “bottom” are used with reference to the direction of diffusion of the test solution through the microfluidic chip 4, the test solution diffusing from the top to the bottom.

“Height” refers to the dimension of an object along the direction of diffusion.

“Diameter” refers to the greatest dimension of an object in a plane perpendicular to the direction of diffusion.

The diffusion profile of a molecule corresponds to the evolution in time of the concentration of this molecule in the solution contained in the receptor compartment 12. The diffusion profile is characteristic of the permeation properties of the molecule through the membrane 14.

The membrane 14 is intended to mimic the skin, and preferably the human skin. For this purpose, it is designed so as to have skin-mimetic barrier properties. Thus, the diffusion profile of the molecule to be tested through the membrane 14 corresponds to its diffusion profile through skin, and more particularly through the human skin.

Advantageously, in order to have skin-mimetic barrier properties, the membrane 14 has:
a composition close to that of the human skin and an arrangement of its molecules similar to the arrangement of the molecules in the human skin; and
a thickness that is approximately equal to the length of the path followed by a molecule diffusing through the human skin.

These features of the human skin are for example described in the article P. S. Talreja, G. B. Kasting, N. K. Kleene, W. L. Pickens, and T.-F. Wang, “Visualization of the lipid barrier and measurement of lipid path length in human stratum corneum,” AAPS Pharmsci, vol. 3, no. 2, pp. 48-56, 2001.

The membrane 14 having skin-mimetic barrier properties may be a fragment of native human skin.

Preferably, the membrane 14 does not comprise any native human skin. It may for example comprise a fragment of animal skin, of reconstructed human skin, a synthetic membrane or a coated membrane.

Advantageously, the membrane 14 mimics the stratum corneum, which is the outermost layer of the human skin. The membrane 14 then acts as a stratum corneum substitute. It has barrier properties that closely mimic that of the stratum corneum. In this case, all the above statements have to be read while replacing skin with stratum corneum.

The composition of the stratum corneum, as well as the arrangement of its molecules is well known. It is for example described in the article entitled “The lipid organization in human stratum corneum and model systems” by Bouwstra et al. published in The Open Dermatology Journal (2010, 4, 10-13).

Advantageously, the membrane 14 has a thickness comprised between 100 and 1000 μm, and more particularly equal to about 125 μm. It has a diffusion surface comprised between 2 mm² and 300 mm², and more particularly equal to about 50 mm².

The membrane 14 comprises a support comprising a porous layer, coated with a mixture of lipids comprising fatty acids, ceramids and cholesterol. The coating e.g. reproduces the composition of the skin or of the stratum corneum, as described, for example, in the articles mentioned above.

The porous layer is advantageously made of a polymer, in particular of polycarbonate. It may also be made of other types of polymers, for example of silicone. Alternatively, it may be made of a non polymeric material such as, for example, glass frit.

The porous layer has a controlled porosity. In particular, the pores of the porous layer have a diameter comprised between 15 nm and 200 nm, and e.g. equal to about 50 nm.

The pores are advantageously obtained by machining. They are for example obtained by laser drilling. They may be rectilinear.

The porous layer has e.g. a thickness comprised between 5 and 30 μm, more particularly comprised between 7 and 22 μm.

The support may further comprise a support layer supporting the porous layer. The support layer may be formed of cellulose or of any other appropriate material. The porosity of the support is preferably controlled by the porosity of the porous layer. The support layer preferably has a random porosity which has substantially no influence on the overall porosity of the support.

The support preferably consists of the porous layer or of the support layer and the porous layer. For example, the support consists of a support layer formed of cellulose and a porous layer formed of polycarbonate. It may also consist of a porous layer formed of silicone, of glass frit or of any other appropriate material.

The lipid coating is applied onto the porous layer. It has e.g. a thickness comprised between 5 and 200 μm, and more particularly comprised between 50 and 70 μm.

The donor compartment 10 is intended to contain the test solution. The test solution contains at least one molecule to be tested, i.e. whose diffusion profile through the skin is to be determined using the installation 1.

According to one embodiment, the test solution contains only one molecule to be tested.

According to an alternative embodiment, the test solution contains more than one molecule to be tested, for example at least two different molecules to be tested.

In the example shown in FIG. 1, the donor compartment 10 is arranged above the receptor compartment 12.

The test solution contained in the donor compartment 10 diffuses through the membrane 14 into the receptor compartment 12 due to passive diffusion, as described by Fick's Law.

The donor compartment 10 comprises a lateral wall 16. In the example shown in FIG. 1, this lateral wall 16 is substantially cylindrical, in particular with a circular base.

The volume of the donor compartment 10 is smaller than 1000 mm³, and more particularly smaller than 250 mm³.

The diameter of the donor compartment 10 is comprised between 2 mm and 15 mm, and more particularly between 5 mm and 10 mm.

Advantageously, the height of the donor compartment 10 is substantially constant across the entire donor compartment 10. This feature guarantees a constant exposure over the surface area during the exposure time.

The donor compartment 10 comprises an opening 11 at its top end in order to allow introduction of the test solution into the donor compartment 10.

The microfluidic chip 4 may comprise a lid for closing the opening 11 once the solution has been introduced into the donor compartment 10. This lid prevents evaporation of the solution contained in the donor compartment 10.

The receptor compartment 12 comprises a bottom 20 and a lateral wall 22 extending upwards from the bottom 20. In the example shown in FIG. 1, the lateral wall 22 is substantially cylindrical, in particular with a circular base. The bottom 20 is e.g. disc-shaped.

The volume of the receptor compartment 12 is smaller than 250 mm³, more particularly smaller or equal to 100 mm³, even more particularly smaller or equal to 20 mm³, advantageously comprised between 10 mm³ and 20 mm³, and for example equal to about 10 mm³.

The diameter of the receptor compartment 12 is equal to that of the donor compartment 10.

The donor compartment 10 is closed at its bottom by the membrane 14, and the receptor compartment 12 is closed at its top by the membrane 14. The smallest dimension of the membrane 14 in a plane perpendicular to the direction of diffusion is advantageously greater than the diameter of the donor compartment 10. For example, the membrane 14 is disc-shaped with a diameter greater than the diameter of the donor compartment 10.

Advantageously, the membrane 14 comprises a top face 17 oriented towards the donor compartment 10 and forming the bottom of the donor compartment 10, and a bottom face 18 oriented towards the receptor compartment 12 and closing the receptor compartment 12 at its top.

The membrane 14 is connected to the donor compartment 10 and to the receptor compartment 12 in a tight manner relative to the test solution. This means that substantially no fraction of the test solution contained in the donor compartment 10 can pass into the receptor compartment 12 without diffusing though the membrane 14.

The receptor compartment 12 is intended to contain a receptor solution. The receptor solution is advantageously a solution which has no influence on the barrier properties of the membrane 14 or on the diffusion properties of the molecule to be tested. It is further preferably a solution in which the molecule to be tested is soluble or in which the molecule to be tested can be in suspension. For example, the receptor solution may be such that the molecule to be tested forms a colloidal suspension in the receptor solution. The molecule to be tested may also be in the form of nanoparticles, which may be in suspension in the receptor solution.

The receptor solution is also preferably such that the molecule to be tested is stable in the receptor solution.

The receptor solution may for example be a buffer solution.

Preferably, the receptor compartment 12 does not contain any stirring device for stirring the solution contained in the receptor compartment 12.

In the example shown in FIG. 1, the receptor compartment 12 comprises an injection inlet 26 and an outlet 28 opening into the receptor compartment 12. The injection inlet 26 is intended for injecting the receptor solution into the receptor compartment 12. The outlet 28 e.g. allows the air to escape from the receptor compartment 12 when the receptor compartment 12 is being filled with the receptor solution.

The injection inlet 26 and the outlet 28 for example each comprise a duct formed in the lateral wall 22 of the receptor compartment 12. This duct may extend upwards through the lateral wall 22 of the receptor compartment 12 and through the lateral wall 16 of the donor compartment 10.

Preferably, the microfluidic chip 4 comprises a first block of material 60 delimiting the donor compartment 10 and a second block of material 62 delimiting the receptor compartment 12. The membrane 14 is sandwiched between the first block of material 60 and the second block of material 62.

The first and second blocks of material 60, 62 may be made of a moldable polymer, such as PDMS (polydimethylsiloxane). They may also be made of other materials, such as glass or a ceramic material.

In particular, the lateral wall 16 of the donor compartment 10 is formed in the first block of material 60 and the lateral wall 22 of receptor compartment 12 is formed in the second block of material 62. The lateral walls 16, 22 are therefore made of the material of the blocks 60, 62.

Advantageously, the second block of material 62 does not form the bottom 20 of the receptor compartment. The bottom 20 is advantageously formed by the top surface of support plate, e.g. a rigid support plate, such as a glass plate, attached to the bottom surface of the second block of material 62.

The installation 1 may further comprise an injector connected to the injection inlet 26 for injecting the receptor solution into the receptor compartment 12.

The analyzer 8 is able to determine the concentration of each molecule to be tested in the solution contained in the receptor compartment 12.

The analyzer 8 is further configured for determining the evolution of the concentration of each molecule to be tested in the solution contained in the receptor compartment 12 as a function of time. This evolution is representative of the diffusion of the molecule to be tested through the membrane 14, and therefore through the skin. The analyzer 8 is thus able to calculate the diffusion profile through skin of each molecule to be tested.

More particularly, the analyzer 8 is configured for measuring a physical parameter of the solution contained in the receptor compartment 12 as a function of time as the test solution diffuses through the membrane 14.

This physical parameter is a parameter which is related to the concentration of the molecule to be tested in the solution contained in the receptor compartment 12 by a known mathematical function, e.g. by a proportionality relation or by any other appropriate mathematical relation depending on the nature of the physical parameter.

Advantageously, the evolution of the measured physical parameter in time is representative of the diffusion of the or each molecule through the membrane 14.

The analyzer 8 is therefore able to obtain, from the measured physical parameter, the evolution in time of the concentration of the molecule to be tested in the solution contained in the receptor compartment 12 as the test solution diffuses through the membrane 14. The analyzer 8 is therefore able to calculate the diffusion profile of the molecule to be tested through the membrane 14 from the measure of the physical parameter.

The nature of the physical parameter depends on the nature of the measurement tool that is used.

Preferably, the analyzer 8 is configured for measuring the physical parameter at a predetermined frequency as the molecule to be tested diffuses through the membrane 14. This predetermined frequency is for example greater than one measurement every 10 minutes, and equal to about one measurement every three to five minutes.

The “solution contained in the receptor compartment 12” analyzed by the analyzer 8 is the solution which is contained in the receptor compartment 12 at the time when the physical parameter is measured by the analyzer 8.

This solution is identical with the receptor solution at the beginning of the experiment, before the test solution has started diffusing through the membrane 14 into the receptor compartment 12. The composition of the solution contained in the receptor compartment 12 changes as the test solution diffuses through the membrane 14 into the receptor compartment 12.

The receptor solution is preferably a solution which has no influence on the value of the physical parameter to be measured by the analyzer 8 or which has a known influence on the value of this physical parameter and can therefore be corrected for when measuring the physical parameter.

The analyzer 8 advantageously measures the physical parameter directly in the receptor compartment 12. In particular, in this embodiment, the analyzer 8 does not analyze any samples of the solution contained in the receptor compartment 12 extracted from the receptor compartment 12 for analysis. Preferably, no fraction of the solution contained in the receptor compartment 12 is extracted from the receptor compartment 12 while the test solution diffuses through the membrane 14.

In the embodiment of the invention shown in FIG. 1, the analyzer 8 comprises an optical measurement system. The physical parameter is an optical property of the solution contained in the receptor compartment 12. The evolution in time of this optical property is representative of the diffusion of the molecule to be tested through the membrane 14.

The optical measurement system comprises:
a light source 34 for emitting a beam of light;
a first optical fiber 36 connected to the light source 34 for conducting the light from the light source 34 into the receptor compartment 12;
a detector 42; and
a second optical fiber 40 for receiving the light transmitted through the receptor compartment 12 and for conducting it to the detector 42.

In this embodiment, the receptor compartment 12 comprises a first optical fiber inlet 44 and a second optical fiber inlet 46. The first and second optical fiber inlets 44, 46 are provided in the lateral wall 22 of the receptor compartment 12. Each optical fiber inlet 44, 46 forms a duct extending through the lateral wall 22 and opening into the receptor compartment 12 at one of its ends.

The second optical fiber inlet 46 is located opposite the first optical fiber inlet 44 across the receptor compartment 12, in particular along the path of the beam of light emitted by the light source 34.

The first optical fiber 36 is at least partially received in the first optical fiber inlet 44. It extends along the entire length of the optical fiber inlet 44.

The second optical fiber 40 is at least partially received in the second optical fiber inlet 46. It extends along the entire length of the optical fiber inlet 46.

The optical fiber inlets 44, 46 are configured so that the first and second optical fibers 36, 40 inserted into these inlets 44, 46 are positioned at a predetermined and constant distance from the detector 42.

The detector 42 is configured for measuring the desired optical property of the solution contained in the receptor compartment 12 by analyzing the light transmitted through this solution.

According to a preferred embodiment of the invention, the optical measurement system is configured for measuring, as the test solution diffuses through the membrane 14 into the receptor compartment 12, the absorbance of the solution contained in the receptor compartment 12 at the wavelength characteristic for the molecule to be tested. It is thus configured for measuring the absorbance of the solution contained in the receptor compartment 12 as a function of time at the wavelength characteristic for the molecule to be tested.

In this embodiment, the physical parameter is the absorbance of the solution contained in the receptor compartment 12 at the wavelength characteristic for the molecule to be tested.

The detector 42 is calibrated so that the concentration of the each molecule to be tested can be determined from the absorbance measured at the wavelength characteristic for this molecule using a known mathematical relation, for example Beer-Lambert's law.

The analyzer 8 is thus able to determine the concentration of the each molecule to be tested in the solution contained in the receptor compartment 12. It is able to determine the evolution in time of the concentration of each molecule to be tested in the solution contained in the receptor compartment 12 from the measurement of the absorbance at the wavelength characteristic for this molecule as a function of time.

The measurement system according to this embodiment is able to simultaneously measure the absorbance of the solution contained in the receptor compartment 12 at as many wavelengths as there are molecules to be tested in the test solution, each wavelength being specific of a molecule to be tested. The analyzer 8 is thus able to simultaneously determine the diffusion profile of several molecules to be tested contained in the test solution, preferably of all the molecules to be tested contained in the test solution.

Advantageously, the optical measurement system described above is a UV-visible absorption spectrometer.

Optionally, the installation 1 further comprises a temperature control device for controlling the temperature in the microfluidic chip 4. The temperature control device may for example comprise a thermostated chamber containing the microfluidic chip 4. The thermostated chamber is for example an incubator or a closed box placed on a heating plate. This thermostated chamber may comprise outlet orifices for the first and second optical fibers 44, 46.

The thermostated chamber is for example configured for maintaining the receptor compartment 12 at a temperature close to that in the human body.

A method for manufacturing the installation 1 will now be explained.

This method comprises a step of forming the first block of material 60 delimiting the donor compartment 10 and the second block of material 62 delimiting the receptor compartment 12.

The first and second blocks of material 60, 62 are for example formed by molding using a mold having the appropriate shape. In this case, the material forming the blocks 60, 62 is, for example, a moldable polymer.

Alternatively, the blocks of material 60, 62 may each be formed by machining or drilling of an appropriate solid starting block. In this case, the material forming the blocks 60, 62 may for example be glass or a ceramic material.

At this stage, the donor compartment 10 and the receptor compartment 12 are preferably open at both ends, i.e. they do not comprise a top and a bottom.

The method further comprises a step of attaching the membrane 14 to the first and second blocks of material 60, 62.

During this attachment step:
One of the faces 17 of the membrane 14 is attached to the first block of material 60 so that it entirely covers one of the ends of the donor compartment 10. This end will form the bottom end of the donor compartment 10.
The opposite face 18 of the membrane 14 is attached to the second block of material 62 so that it entirely covers one of the ends of the receptor compartment 12. This end will be the top end of the receptor compartment 12.

At the end of this step, the membrane 14 is sandwiched between the thus treated first and second blocks of material 60, 62.

During this attachment step, the membrane 14 is attached to the first and second blocks of material 60, 62 in a tight manner.

For this purpose, the first and second blocks of material 60, 62 are for example treated in order to be able to adhere to the membrane 14 sandwiched between these two blocks of material 60, 62.

If the blocks of material 60, 62 are made of a siloxane-based material, they may be treated using a plasma torch in order to achieve chemical bonding between the membrane 14 and the first and second blocks of material 60, 62.

If the first and second blocks of material 60, 62 are made of a thermoplastic material, they may be heat treated.

Alternatively, the first block of material 60, 62 may be attached to the membrane 14 in a tight manner through mechanical fastening and sealing means.

Optionally, the bottom surface of the second block of material 62 is attached to the support plate in such a way that the support plate forms the bottom 20 of the receptor compartment 12.

The method further comprises a step of inserting the first and second optical fibers 36, 40 respectively into the first and second optical fiber inlets 44, 46 and of connecting these first and second optical fibers 36, 40 respectively to the light source 34 and to the detector 42.

The installation 1 according to a first alternative to the first embodiment differs from the installation 1 according to the first embodiment only in that the optical measurement system comprises a device for determining the concentration of the or each molecule in the receptor compartment 12 through Raman absorption spectroscopy.

The analyzer 8 according to this embodiment differs from the analyzer 8 according to the first embodiment only in that the optical property measured by the optical measurement system is the intensity of the light transmitted through the solution contained in the receptor compartment 12 at a predetermined wavelength characteristic of the molecule to be tested. It is the Raman scattering intensity of the solution contained in the receptor compartment 12 at the predetermined wavelength.

In this embodiment, the light source 34 is configured for emitting a monochromatic light beam and the predetermined wavelength corresponds to the wavelength to which the wavelength of the incident light beam is shifted due to the presence of the molecule to be tested in the solution.

The detector 42 is calibrated in such a way that it can determine the concentration of the molecule to be tested in the solution contained in the receptor compartment 12 from the measured intensity by applying a known mathematical function, for example a simple proportionality relation.

The detector 42 according to this embodiment is able to simultaneously measure the intensity of the light transmitted through the solution contained in the receptor compartment 12 at as many predetermined wavelengths as there are molecules to be tested in the test solution.

The analyzer 8 is thus able to simultaneously determine the diffusion profile of several molecules to be tested contained in the test solution, preferably of all the molecules to be tested contained in the test solution.

The installation 1 according to a second alternative of the first embodiment differs from the installations 1 described above only in that the optical measurement system comprises a fluorometer.

The installation 1 according to this embodiment may be used if the molecule to be tested is a molecule which emits fluorescence when excited at a given wavelength.

In this embodiment, the light source 34 is configured for emitting light having the wavelength required to excite the molecule to be tested. The detector 42 is configured for measuring the intensity of the light received from the second optical fiber 40, i.e. transmitted from the light source 34 through the solution contained in the receptor compartment 12. The detector 42 is calibrated in such a way that the measured intensity is proportional to the concentration of the molecule to be tested in the solution contained in the receptor compartment 12.

In this embodiment, the optical property measured by the optical measurement system is the intensity of the fluorescence measured by the detector 42.

Alternatively, the optical property measured by the optical measurement system may be the refractive index or the optical rotation of the solution contained in the receptor compartment 12.

Alternatively to the measurement systems described above, any other analytical measurement system which allows measuring a physical parameter of the solution contained in the receptor compartment as the test solution diffuses through the membrane 14 into the receptor compartment 12, directly in the receptor compartment 12, and without sampling, could be used. The physical parameter is related to the concentration by a known mathematical relation.

The invention also relates to a method for determining the diffusion profile of at least one molecule through skin using the installation 1 described above.

This method comprises steps of:
injecting a receptor solution into the receptor compartment 12;
introducing a test solution containing at least one molecule to be tested into the donor compartment 10;
determining the concentration of the molecule to be tested in the solution contained in the receptor compartment 12 as a function of time as the molecule diffuses through the membrane 14 using the analyzer 8; and
determining the diffusion profile of the molecule to be tested through skin from the evolution of the concentration of this molecule as a function of time in the solution contained in the receptor compartment 12.

In particular, the step of determining the concentration of the molecule to be tested as a function of time comprises a step of measuring, directly in the receptor compartment 12, the physical parameter of the solution contained in the receptor compartment 12 as the molecule to be tested diffuses through the membrane 14, and a step of calculating the concentration of the molecule to be tested in the solution contained in the receptor compartment from the measured physical parameter.

The dose of the test solution in the donor compartment 10 is for example comprised between 2 mg of solution per square centimeter of membrane 14 and several hundreds of mg of solution per square centimeter of membrane 14.

In particular, the dose of the test solution introduced into the donor compartment 10 is for example comprised between 2 and 10 mg of solution per square centimeter of membrane 14 for finite dose evaluation.

For infinite dose evaluation, the test solution is e.g. saturated with the molecule to be tested. The dose of the test solution in the donor compartment 10 is e.g. in the range of several hundreds of mg of solution per square centimeter of membrane 14. More particularly, the amount of the test solution to be tested is comprised between about 50 and 500 μl per cm² of membrane 14, and more particularly equal to about 250 μl per cm² of membrane 14.

The method may further comprise a step of determining the permeation coefficient of the molecule through skin. The permeation coefficient is obtained from the diffusion profile, in particular by calculating the ratio between the slope of the linear portion of the measured diffusion profile and the initial concentration of the molecule to be tested in the donor compartment 10. The linear portion of the diffusion profile corresponds to the steady-state diffusion.

The installation 1 and method according to the invention are particularly advantageous.

Indeed, they allow getting a continuous measurement of the diffusion process, without sampling and without having to dismantle the microfluidic chip 4.

The fact that the measurement is carried out as the molecule to be tested diffuses through the membrane 14 is advantageous. Indeed, it makes it possible to obtain an extensive number of data points and thus improves the quality of the information on the diffusion process.

Furthermore, avoiding sampling also improves the accuracy of the measurements, since it avoids any perturbation of the system which would have resulted from the extraction of samples. Avoiding sampling also simplifies the measurements and makes it easy to automate the process.

Therefore, the installation according to the invention allows measuring the diffusion properties of molecules in a convenient manner and with a high throughput.

The microvolume of the receptor compartment 12 makes it possible to get a homogenous concentration by only diffusion in a few seconds, thus avoiding the use of a stirring device. Moreover, it allows having a high enough concentration of the molecule to be tested in the receptor compartment 12 to be above the detection limits of the measurement tools at all times during the diffusion of the test solution through the membrane 14. This contributes to allowing the measurement of the physical parameter as the test solution diffuses through the membrane 14.

FIG. 2 illustrates an installation 201 according to a second embodiment of the invention. The installation 201 according to the second embodiment of the invention differs from the previously described installation 1 only in that the analyzer 208 comprises an electrochemical measurement tool configured for measuring electrochemical properties of the solution contained in the receptor compartment 212. Furthermore, the receptor compartment 212 does not comprise any optical fiber inlets.

Advantageously, the electrochemical measurement tool is configured for measuring the electrical conductivity of the solution contained in the receptor compartment 212. In this embodiment, the physical parameter measured by the analyzer 208 is the electrical conductivity of the solution contained in the receptor compartment 212. Its evolution in time is representative of the diffusion of the molecule to be tested through the membrane 214.

The electrochemical measurement tool comprises at least two electrodes 230. These electrodes 230 are preferable plane electrodes, made, for example, of platinum.

In this embodiment, the bottom 220 of the receptor compartment 212 is advantageously formed by a support plate, for example made of glass, attached to the block of material 262.

The electrodes 230 may be arranged on the bottom 220 of the receptor compartment 212. In particular, the electrodes 230 may be coated onto the bottom 220 of the receptor compartment 212.

The electrodes 230 may for example be formed by depositing the metal intended to form the electrodes 230 onto the bottom 220 of the receptor compartment 212 followed by patterning the deposited metal in order to obtain electrodes 230 having the desired shape. The deposition is carried out by conventional deposition techniques such as evaporation or sputter. The patterning is carried out in a conventional manner, for example by photolithography followed by etching.

Advantageously, the electrodes 230 are arranged on the bottom 220 of the receptor compartment 212 near the lateral walls of the receptor compartment 212.

Alternatively, the electrodes 230 may be arranged in the inlet 26 and outlet 28 of the receptor compartment 12.

The analyzer 8 comprises the electrodes 230 for measuring the electrical conductivity of the solution contained in the receptor compartment 212, as well as a detector 242 configured for determining the concentration of the molecule to be tested in the solution contained in the receptor compartment 212 from the measured conductivity. The detector 242 is adequately calibrated. Thus, the concentration of the molecule to be tested is proportional to the measured conductivity.

The physical parameter, i.e. the electrical conductivity, is measured directly on the solution contained in the receptor compartment 212. It is measured as the test solution diffuses through the membrane 14. Therefore, the analyzer 208 is configured for measuring the electrical conductivity as a function of time during the diffusion of the test solution through the membrane 14, and for determining the diffusion profile of the molecule to be tested from the measured electrical conductivity.

According to an alternative to the second embodiment, the installation 201 differs from the installation according to the second embodiment only in that the electrochemical measurement tool is a tool for measurement by amperometry. The tool for measurement by amperometry comprises at least two electrodes located in the receptor compartment 212.

In this embodiment, the physical parameter measured by the analyzer 208 is the intensity of the current passing through the solution contained in the receptor compartment 212 when a predetermined voltage is applied between the electrodes. Its evolution in time is representative of the diffusion of the molecule to be tested through the membrane 214.

The tool for measurement by amperometry advantageously comprises three electrodes, for example one reference electrode made of Ag/AgCl, one reference electrode made of gold, and one working electrode made of modified gold, for example of gold modified by polymer membranes or immobilized enzymes. The gold of the working electrode is modified so as to be selective of the molecule to be tested. Therefore, the measured intensity is proportional to the concentration of the molecule to be tested in the receptor solution.

The analyzer 208 comprises the electrodes, as well as a detector 242 configured for determining the concentration of the molecule to be tested in the solution contained in the receptor compartment 212 from the measured current. The detector 242 is adequately calibrated. Thus, the concentration of the molecule to be tested is proportional to the measured current.

The physical parameter, i.e. the electrical current, is measured directly on the solution contained in the receptor compartment 212. It is also measured as the test solution diffuses through the membrane 14. Therefore, the analyzer 208 is configured for measuring the electrical current as a function of time during the diffusion of the test solution through the membrane 14, and for determining the diffusion profile of the molecule to be tested from the measured current.

The installation 1 according to a third embodiment differs from the installation 201 according to the second embodiment only in that the analyzer 8 does not comprise an electrochemical measurement tool. In this embodiment, the analyzer 8 comprises a pH measurement tool. In particular, the analyzer 8 comprises a pH probe for measuring the pH of the solution contained in the receptor compartment 12. The pH probe extends into the receptor compartment 12.

In such a case, the receptor solution used is not a buffer solution.

In this embodiment, the physical parameter measured by the analyzer 8 is the pH of the solution contained in the receptor compartment 12.

The detector 42 is configured for determining the concentration of the molecule to be tested in the solution contained in the receptor compartment 12 from the measured pH of the solution. For this purpose, the detector 42 is adequately calibrated.

The analyzer 8 is thus able to measure the pH of the solution contained in the receptor compartment 12 as a function of time during the diffusion of the test solution through the membrane 14, directly in the receptor compartment 12, i.e. without sampling, and to determine the diffusion profile of the molecule to be tested from the measured pH.

The installation 1 according to the invention may further comprise any technically possible combination of the above-mentioned analyzers 8. In this case, a same installation 1 may be used regardless of the properties of the molecules to be tested.

The physical parameter that will be measured by the installation 1 depends on the properties of the molecule to be tested.

For example, if the molecule to be tested is ionized, the physical parameter measured may be the electrical conductivity of the solution contained in the receptor compartment 12.

If the molecule to be tested modifies the pH of the receptor solution, the physical parameter measured may be the pH of the solution contained in the receptor compartment 12.

If the molecule to be tested is known to emit fluorescence when excited at a given wavelength, the physical parameter measured may be the intensity of the light received by the detector 42 when a beam of light of the given wavelength is transmitted through the solution contained in the receptor compartment 12.

If the molecule is known to absorb light at a given wavelength, the physical parameter measured may be the absorbance of the solution.

If the molecule is known to shift the wavelength of the incident light to another wavelength, the physical parameter measured may be the intensity at that wavelength of the light transmitted through the solution.

The method for determining the diffusion profile of at least one molecule through skin using the installations according to the second and third embodiments is analogous to the one described with respect to the first embodiment, the only difference being the nature of the physical parameter measured.

The invention also relates to an installation comprising at least two microfluidic chips connected in parallel to a same detector.

Advantageously, the analyzer is an analyzer intended for analyzing an electrochemical property of the solution contained in the receptor compartment. In this embodiment each microfluidic chip is a chip according to the second embodiment or its alternative. The analyzer comprises at least two electrodes in each microfluidic chip. The electrodes of the different microfluidic chips of the installation are all connected to a same detector configured for measuring an electrochemical property of the solution contained in the receptor compartment of each microfluidic chip and for determining the diffusion profile of the molecule to be tested in each of these microfluidic chips.

As an alternative, the installation comprises at least two microfluidic chips connected in parallel to a same detector, the detector being configured for measuring an optical property of the solution contained in the receptor compartments. In this alternative embodiment, each of the microfluidic chips is a microfluidic chip according to the first embodiment described above, and the analyzer comprises first and second optical fibers received in the optical fiber inlets of each of the microfluidic chips of the installation. The first optical fibers of all the microfluidic chips are connected to a same light source and the second optical fibers of all the microfluidic chips are connected to a same detector for measuring the optical property of the solution contained in each of the receptor compartments from the light transmitted through the respective second optical fiber and for determining the diffusion profile of the molecule to be tested in the respective microfluidic chip. The detector may comprise an optical switch allowing the detector to switch between the measurements in the different microfluidic chips of the installation at a predetermined rate.

Such installations are advantageous, since they allow implementing several assays in parallel while taking up a minimum space, since the total surface occupied by each microfluidic chip is small.

The invention also relates to an installation 301 for determining the diffusion profile of at least one molecule through skin as shown in FIG. 3.

The installation 300 comprises a microfluidic chip 304 and an analyzer 308 for determining the diffusion profile of the or each molecule through the skin.

The microchip 304 is substantially identical to the microchip 4 of the installation 1 according to the first embodiment, except that the receptor compartment 312 of the microchip 304 does not comprise any inlets for the passage of optical fibers.

The volume of the receptor compartment 312 is smaller than 250 mm³, particularly smaller or equal to 100 mm³, even more particularly smaller or equal to 20 mm³. Advantageously, it is comprised between 10 mm³ and 20 mm³, and for example equal to 10 mm³.

Advantageously, the height of the receptor compartment 312 is substantially constant across the entire receptor compartment 312.

Advantageously, the diameter of the receptor compartment 312 is comprised between 2 mm and 15 mm, and more particularly between 5 mm and 10 mm.

The analyzer 308 differs from the previously described analyzers 8, 208 in that it does not measure the physical parameter in the receptor compartment 312.

In the installation 300, the analyzer 308 comprises a measurement tool 315 configured for measuring the physical parameter of the solution contained in the receptor compartment 312 on samples of this solution extracted from the receptor compartment 312. The measurement tool 315 is therefore configured for measuring the physical parameter of the solution contained in the receptor compartment 312 outside of the receptor compartment 312.

Each sample has a known, predetermined volume. Preferably, all the extracted samples have the same volume.

In this context, the volume of the sample may be less than 100% of the volume of the solution contained in the receptor compartment 312 at the time of the extraction. It may also be 100% of the volume of the solution contained in the receptor compartment 312 at the time of the extraction.

The measurement tool 315 is advantageously a mass spectrometer, e.g. a mass spectrometer with a classical ESI (short for “electrospray ionization”) ion source or with a nano-ESI ion source.

In this case, the physical parameter is, e.g. the response of the molecule to be tested in the ionization mode of the mass spectrometer used, determined by measuring the mass to charge ratio (m/z) of the molecule to be tested in each analyzed sample. The mass spectrometer is calibrated previously for each analytical run such that the concentration of the molecule to be tested in the solution contained in the receptor compartment 312 at the time when the sample was extracted is related to the response of the molecule to be tested by a known mathematical relation.

The installation 300 further comprises an extraction means 313 configured for extracting the sample to be analyzed from the receptor compartment 312 and for transferring it to the measurement tool 315, in particular into the ion source of the mass spectrometer, as the test solution diffuses through the membrane 314. The extraction means 313 is for example a pump, connected to the outlet 328 of the receptor compartment 312, e.g. through a connection tubing.

In particular, the analyzer 308 is configured for controlling the automatic extraction of a sample from the receptor compartment 312 at a predetermined frequency as the test molecule diffuses through the membrane 314. In particular, the predetermined frequency is greater than one extraction every ten minutes, and for example equal to about one extraction every three to five minutes.

Therefore, a plurality of samples is extracted from the receptor compartment 312 as the test solution diffuses through the membrane 314.

The analyzer 308 may further be configured for controlling the automatic injection of a corresponding volume of receptor solution into the receptor compartment 312 through the inlet 326 as soon as the sample has been extracted from the receptor compartment 312 by the extraction means 313.

The measurement tool 315 is configured for analyzing each sample extracted from the receptor compartment 312, and for determining the value of the physical parameter in this sample. In particular, when the measurement tool 315 is a mass spectrometer, it is able to measure the response of the molecule to be tested in the sample.

The analyzer 308 is further configured for determining the diffusion profile of the molecule to be tested through the membrane 314 from the values of the physical parameter measured in the plurality of samples extracted from the receptor compartment 312 during the diffusion of the test solution through the membrane 314.

In particular, when the measurement tool 315 is a mass spectrometer, the analyzer 308 is able to determine the diffusion profile of all the molecules contained in the samples extracted from the receptor compartment 312 which can be ionized by the ion source of the mass spectrometer.

The invention also relates to a method for determining the diffusion profile of at least one molecule through skin using the installation 301 described above.

This method comprises steps of:
injecting a receptor solution into the receptor compartment 312;
introducing a test solution containing at least one molecule to be tested into the donor compartment 310;
determining the concentration of the molecule to be tested in the solution contained in the receptor compartment 312 as a function of time as the molecule diffuses through the membrane 314 using the analyzer 308; and
determining the diffusion profile of the molecule to be tested through skin from the evolution of the concentration of this molecule as a function of time in the solution contained in the receptor compartment 312.

In particular, the step of determining the concentration of the molecule to be tested as a function of time comprises a step of measuring the physical parameter on a plurality of samples extracted from the receptor compartment 312 as the test solution diffuses through the membrane 14, and a step of calculating the concentration of the molecule to be tested in the solution contained in the receptor compartment 312 from the measured physical parameter using the known mathematical relation between the physical parameter and the concentration.

In the installation 301, the small size of the receptor compartment 312, which has a volume smaller than 250 mm³, more particularly smaller or equal to 100 mm³, even more particularly smaller or equal to 20 mm³, advantageously comprised between 10 mm³ and 20 mm³, and for example equal to about 10 mm³ is particularly advantageous.

Indeed, it allows obtaining a good homogeneity of the solution in the receptor compartment 312 without stirring, which is important for the accuracy of the measurement results.

Moreover, it allows obtaining a sufficiently high concentration of the molecule to be tested in the solution contained in the receptor compartment 312 at all times, even though samples of this solution are extracted from the receptor compartment 312 and new receptor solution is injected into the receptor compartment 312 during the diffusion of the test solution through the membrane 314. In particular, the concentration is always greater than the detection limits of the measurement tool. It is therefore possible to monitor the evolution of the concentration of the molecule to be tested in the receptor compartment 312 as a function of time during the diffusion of this molecule through the membrane 314, and to determine a diffusion profile of the molecule through the membrane 314, and thus through the skin.

Due to the particular configuration of the installation 301, the microfluidic chip 304 does not have to be dismantled in order to determine the concentration of the molecule to be tested in the receptor compartment 314. The samples are automatically extracted from the receptor compartment 312 and the receptor compartment 314 is automatically refilled with the corresponding volume of new receptor solution.

1. Installation for determining the diffusion profile of at least one molecule through skin, comprising:
a microfluidic chip comprising:
a donor compartment intended to contain a test solution comprising the or each molecule;
a receptor compartment intended to contain a receptor solution; and
a membrane with skin-mimetic barrier properties arranged between the donor compartment and the receptor compartment so that the test solution diffuses through the membrane from the donor compartment into the receptor compartment;
and
an analyzer configured for measuring a physical parameter of the solution contained in the receptor compartment as the test solution diffuses through the membrane, and said analyzer being configured for measuring the physical parameter in the receptor compartment, the analyzer being further configured for calculating the diffusion profile of the or each molecule through skin from the measured physical parameter.

2. Installation according to claim 1, wherein the receptor compartment has a volume smaller than 250 mm³.

3. Installation according to claim 1, wherein the physical parameter is related to the concentration of the or each molecule to be tested in the solution contained in the receptor compartment by a known mathematical function.

4. Installation according to claim 1, wherein the evolution of said physical parameter in time is representative of the diffusion of the or each molecule through the membrane.

5. Installation according to claim 1, wherein the physical parameter is chosen among the list comprising: an optical property of the solution contained in the receptor compartment, an electrochemical property of the solution contained in the receptor compartment and the pH of the solution contained in the receptor compartment.

6. Installation according to claim 1, wherein the physical parameter comprises an optical property of the solution contained in the receptor compartment, and the analyzer comprises an optical measurement system configured for measuring this optical property in the receptor compartment as the test solution diffuses through the membrane.

7. Installation according to claim 6, wherein the optical measurement system comprises a light source for emitting a beam of light, a detector configured for analyzing the light transmitted through the solution contained in the receptor compartment in order to measure the physical parameter, a first optical fiber connected to the light source for conducting the light from the light source into the receptor compartment and a second optical fiber connected to the detector for conducting the light from the receptor compartment to the detector.

8. Installation according to claim 7, wherein the receptor compartment comprises a first optical fiber inlet (44) and a second optical fiber inlet located opposite one another across the receptor compartment, the first optical fiber being received in the first optical fiber inlet and the second optical fiber being received in the second optical fiber inlet.

9. Installation according to claim 5, wherein the optical property is chosen among the list comprising: the absorbance of the solution contained in the receptor compartment at a given wavelength, the intensity of fluorescence of the solution contained in the receptor compartment, the refractive index of the solution contained in the receptor compartment, the optical rotation of the solution contained in the receptor compartment and the Raman scattering intensity of the solution contained in the receptor compartment at a given wavelength.

10. Installation according to claim 1, wherein the physical parameter comprises an electrochemical property of the solution contained in the receptor compartment and the analyzer comprises an electrochemical measurement tool configured for measuring this electrochemical property in the receptor compartment as the test solution diffuses through the membrane.

11. Installation according to claim 10, wherein the electrochemical measurement tool comprises at least two electrodes configured for measuring, as the test solution diffuses through the membrane, the electrical conductivity of the solution contained in the receptor compartment or the electrical current passing through the solution contained in the receptor compartment.

12. Installation according to claim 1, wherein the receptor compartment comprises a lateral wall, and at least injection inlet provided in the lateral wall and opening into the receptor compartment for injecting the receptor solution into the receptor compartment.

13. Installation according to claim 1, wherein the donor compartment is closed at its bottom by the membrane, the donor compartment comprising an opening at its top intended for the introduction of the test solution into the donor compartment.

14. Installation according to claim 1, wherein the microfluidic chip comprises a first block of material delimiting the donor compartment and a second block of material delimiting the receptor compartment, the membrane being sandwiched between the first block of material and the second block of material

15. Method for determining the diffusion profile of at least one molecule through skin using the installation according to claim 1, comprising steps of:
injecting a receptor solution into the receptor compartment;
injecting a test solution containing at least one molecule to be tested into the donor compartment;
measuring the physical parameter in the receptor compartment as the test solution diffuses through the membrane; and
determining the diffusion profile of the or each molecule to be tested through skin from the measured physical parameter.

16. Installation according to claim 1, wherein the receptor compartment has a volume smaller or equal to 100 mm³.

17. Installation according to claim 1, wherein the receptor compartment has a volume smaller or equal to 20 mm³.

18. Installation according to claim 2, wherein the physical parameter is related to the concentration of the or each molecule to be tested in the solution contained in the receptor compartment by a known mathematical function.

19. Installation according to claim 2, wherein the evolution of said physical parameter in time is representative of the diffusion of the or each molecule through the membrane.

20. Installation according to claim 3, wherein the evolution of said physical parameter in time is representative of the diffusion of the or each molecule through the membrane.
